(19) United States
(12) Patent Application Publication
(10) Pub. No.: US 2010/0269069 A1
(43) Pub. Date: Oct. 21, 2010

(54) METHOD AND APPARATUS OF ASSOCIATING AND MAINTAINING STATE INFORMATION FOR APPLICATIONS

(75) Inventors: Toni Paila, Koisjarvi (FI); Ari Antero Aarnio, Espoo (FI)

Correspondence Address: DITTHAVONG MORI & STEINER, P.C., 918 Prince Street, Alexandria, VA, 22314, US

(73) Assignee: Nokia Corporation, Espoo (FI)

(21) Appl. No.: 12/425,904

(22) Filed: Apr. 17, 2009

(51) Int. Cl. G06F 3/048

(52) U.S. Cl. 715/835

(57) ABSTRACT

An approach is provided for associating applications, such as widgets. Presentation of one or more icons representing respectively one or more widgets is initiated. An input signal is detected in response to a user selecting the one or more widgets. A determination is made of a common action for application to the selected widgets based on the input signal. The application includes a data component relating to combinability of the one or more widgets. In one embodiment, state information about a first application (e.g., widget) is generated. Reporting of the state information is provided to a presence service for access by a second application (e.g., widget).

### BACKGROUND

Wireless (e.g., cellular) service providers and device manufacturers are continually challenged to deliver value and convenience to consumers by, for example, providing compelling network services, applications, and content, as well as user-friendly devices. An important differentiator in this industry is the user interface. In particular, light-weight applications also widely known as widgets have emerged as a convenient means for presenting information and accessing services. These widgets provide basic components of graphical user interfaces (GUIs) for users to interact with applications, and enable more robust and user-friendly controls for user devices.

### SOME EXAMPLE EMBODIMENTS

According to one embodiment, a method comprises initiating presentation of one or more icons representing respectively one or more widgets; detecting an input signal in response to a user selecting the widgets; and determining a common action for application to the selected widgets based on the input signal, wherein the application includes a data component relating to combinability of the one or more widgets.

According to another embodiment, a computer-readable medium carries one or more sequences of one or more instructions which, when executed by one or more processors, cause an apparatus to perform at least the following: initiating presentation of one or more icons representing respectively one or more widgets; detecting an input signal in response to a user selecting the widgets; and determining a common action for application to the selected widgets based on the input signal, wherein the application includes a data component relating to combinability of the one or more widgets.

According to another embodiment, an apparatus comprises at least one processor, and at least one memory including computer program code. The at least one memory and the computer program code is configured to, with the at least one processor, cause the apparatus to perform at least the following: initiate presentation of one or more icons representing respectively one or more widgets, detect an input signal in response to a user selecting the widgets, and determine a common action for application to the selected widgets based on the input signal, wherein the application includes a data component relating to combinability of the one or more widgets.

According to another embodiment, an apparatus comprises means for initiating presentation of one or more icons representing respectively one or more widgets; means for detecting an input signal in response to a user selecting the widgets; and means for determining a common action for application to the selected widgets based on the input signal, wherein the application includes a data component relating to combinability of the one or more widgets.

According to another embodiment, a method comprising generating state information about a first application; and initiating reporting of the state information to a presence service for access by a second application.

According to another embodiment, a computer-readable medium carries one or more sequences of one or more instructions which, when executed by one or more processors, cause an apparatus to perform at least the following: generating state information about a first application; and initiating reporting of the state information to a presence service for access by a second application.

According to another embodiment, a method comprising generating state information about a first application, and initiating reporting of the state information to a presence service for access by a second application.

According to another embodiment, an apparatus comprises at least one processor, and at least one memory including computer program code. The at least one memory and the computer program code is configured to, with the at least one processor, cause the apparatus to perform at least the following: generate state information about a first application, and initiate reporting of the state information to a presence service for access by a second application.

According to yet another embodiment, an apparatus comprises means for generating state information about a first application; and means for initiating reporting of the state information to a presence service for access by a second application.

Still other aspects, features, and advantages of the invention are readily apparent from the following detailed description, simply by illustrating a number of particular embodiments and implementations, including the best mode contemplated for carrying out the invention. The invention is also capable of other and different embodiments, and its several details can be modified in various obvious respects, all without departing from the spirit and scope of the invention. Accordingly, the drawings and description are to be regarded as illustrative in nature, and not as restrictive.

### BRIEF DESCRIPTION OF THE DRAWINGS

The embodiments of the invention are illustrated by way of example, and not by way of limitation, in the figures of the accompanying drawings:

FIG. 1 is a diagram of a system capable of providing state information among applications, e.g. widgets, according to one embodiment;

FIG. 2 is a flowchart of a process for reporting state information to a presence service, according to one embodiment;

FIG. 3 is a flowchart of a process for sharing state information among applications, according to one embodiment;

FIG. 4 is a flowchart of a process for associating applications, according to one embodiment;

FIGS. 5A and 5B are, respectively, a flowchart of a process for displaying the association of applications, and a diagram of a visual presentation of the association, according to various embodiments;

FIGS. 6-8 are diagrams of a multi-touch user interface for associating widgets, according to various embodiments;

FIG. 9 is a diagram of hardware that can be used to implement an embodiment of the invention;

FIG. 10 is a diagram of a chip set that can be used to implement an embodiment of the invention; and

FIG. 11 is a diagram of a mobile station (e.g., handset) that can be used to implement an embodiment of the invention.

### DESCRIPTION OF PREFERRED EMBODIMENTS

A method and apparatus for associating applications, such as widgets, and providing context information, such as state information, and/or content information among the applications are disclosed. In the following description, for the purposes of explanation, numerous specific details are set forth in order to provide a thorough understanding of the embodiments of the invention. It is apparent, however, to one skilled in the art that the embodiments of the invention may be practiced without these specific details or with an equivalent arrangement. In other instances, well-known structures and devices are shown in block diagram form in order to avoid unnecessarily obscuring the embodiments of the invention.

Although various embodiments are described with respect to widgets, it is contemplated that the approach described herein may be used with other applications.

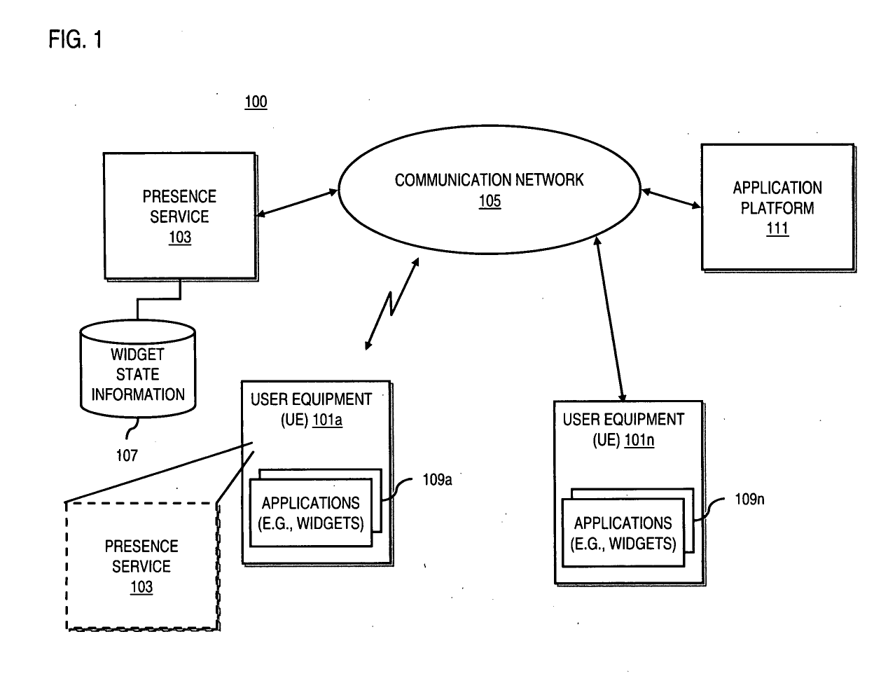

FIG. 1 is a diagram of a system capable of providing state information among applications, e.g. widgets, according to one embodiment. System 100 provides management of widgets, whereby state information of these widgets are maintained. In addition, the widgets can be manipulated using a user interface that permits simultaneous selection of such widgets for invoking a common action, for example. The widgets can be represented as icon-like active mini-views of services; both referred to as “icons” hereinafter. As shown in FIG. 1, system 100 comprises one or more user equipment (UEs), e.g., UEs 101a-101n, having connectivity to a presence service application or platform 103 via a communication network 105. The UEs 101a-101n are any type of mobile terminal, fixed terminal, or portable terminal including mobile handsets, mobile phones, mobile communication devices, stations, units, devices, multimedia tablets, digital book readers, game devices, audio/video players, digital cameras/camcorders, positioning device, televisions, radio broadcasting receivers, Internet nodes, communicators, desktop computers, laptop computers, Personal Digital Assistants (PDAs), or any combination thereof. Under this scenario, the UE 101a employs a radio link to access network 105, while connectivity of UE 101n to the network 105 can be provided over a wired link. It is also contemplated that the UEs 101a-101n can support any type of interface to the user (such as “wearable” circuitry, etc.). The platform 103 stores state information within a database 107 for the applications 109a resident on the UEs 101a-101n. In one embodiment, such state information can be rich state information. For example, via the presence service platform 103, widget 109a can use rich state information of another widget, e.g., widget 109n, to modify its own state and properties. Although shown as a standalone application, it is contemplated that presence service 103 along with the database (or memory) 107 can be deployed within the user equipment (e.g., as shown within UE 101a).

According to one embodiment, the applications, e.g. widgets, 109a-109n can be supplied and/or operate in conjunction with an application platform 111. For example, the widgets 109a-109n can be downloaded at the request of the user, or alternatively, be delivered based on a service operated by a service provider. By way of illustration, the widgets 109a-109n are authored so that they use the presence service 103 to report their own status as well as and query other widgets' status information. Depending on the deployment, widget 109a may periodically access presence service to learn about changes to the status of widget 109b. A widget can thus be regarded as a user interface element, and can be downloadable and support software that provides a variety of content information, e.g., news, stock quotes, weather forecasts, maps, location information, advertisement, calendars, calendar information, contact information, messages, emails, service guide information, recommendations, audio files, video files, radio/television broadcasting, etc. A widget may be configured to continuously receive content information, such as continuously updated content, from one or more sources.

By way of example, widgets 109a, which are denoted widget icon A (or simply widget A) and widget B, are displayed on the UE 101a. Widget A is moved next to widget B, causing widget A to update its location on the display and status/content information to the presence application, e.g., presence service 103. The presence service 103 determines location of widget A in relation to other widgets, whereby widget B is found to be next to widget A. Further, the presence service 103 sends update of status/content information of widget A to widget B, which updates its activity/information based on the received update. Also, widget B can request update from the presence service 103; this service 103 sends update of status/content information of widget A to widget B. Subsequently, widget B updates its activity/information based on the received update.

Furthermore, one or more of the UEs 101a-101n, in certain embodiments, can utilize an input mechanism (e.g., touch screen, mouse, cursor controls, keys, etc.) that permits manipulation of their respective widgets 109a-109n. In one embodiment, the input mechanism is a touch screen user interface, e.g., a multi-touch screen, to permit a user to simultaneously, concurrently, and/or sequentially select different widgets for associating them. Widgets 109a-109n may be arranged and displayed on a dashboard that is located in a predetermined area within a graphical user interface (GUI) or display. The user equipment 101a can visually display, for instance, two widgets coming moving towards each other analogous to two magnets that are attracted. Thus, the user can discern that the selected widgets can be combined (e.g., share a common action) because of the magnetic attraction—i.e., movement in a magnetic attraction manner. Moreover, the user can be notified that the widgets cannot be combined, when the widgets repel, whereby the movement of the widgets resemble that of two magnets repelling. In one embodiment, the ability to be combined can be specified as part of the state information stored within the presence service database 107.

According to certain embodiments, widgets 109a-109n may comprise one or more components that define data type or the like for the different data components that are included. These widgets 109a-109n may be labeled with “+” and “−” indications or the like or the identity to notify the user which one is attractive and which one is repulsive (i.e., their magnetic properties). Such indications can change depending on neighboring widgets and/or data components of those widgets. These data components can have the properties that can individually communicate with the other respective components in other widgets. One example is “update” of this particular data component. In this way, this updated component data can be shared with other widgets. For example, the data components may include a clock functionality, whereby this clock functionality of one widget can be provided to other widget when these widgets are positioned close to one another widget that does not have (but can accommodate) this feature. In other words, the widget can be placed in a mode where it attracts a clock functionality that is to be included as one data component when these two widgets are moved close enough. The data components may possess properties that indicate different level, or degrees, of attraction or repulsion (e.g., 40% minus or 60% plus).

By way of example, the communication network 105 of system 100 includes one or more networks such as a data network (not shown), a wireless network (not shown), a telephony network (not shown), or any combination thereof. It is contemplated that the data network may be any local area network (LAN), metropolitan area network (MAN), wide area network (WAN), the Internet, or any other suitable packet-switched network, such as a commercially owned, proprietary packet-switched network, e.g., a proprietary cable or fiber-optic network. In addition, the wireless network may be, for example, a cellular network and may employ various technologies including enhanced data rates for global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., microwave access (WiMAX), Long Term Evolution (LTE) networks, code division multiple access (CDMA), wireless fidelity (WiFi), satellite, mobile ad-hoc network (MANET), and the like. In addition, the wireless network may be, for example, a short range network, such a Bluetooth® network, ultra wide band (UWB) network, radio frequency identification (RFID) network or infrared network (IrDA).

By way of example, the UEs 101a-101n communicate with the presence service platform 103 over the communication network 105 using standard protocols. The UEs 101a-101n and the platform 103 are network nodes with respect to the communication network 105. In this context, a protocol includes a set of rules defining how the network nodes within the communication network 105 interact with each other based on information sent over the communication links. The protocols are effective at different layers of operation within each node, from generating and receiving physical signals of various types, to selecting a link for transferring those signals, to the format of information indicated by those signals, to identifying which software application executing on a computer system sends or receives the information. The conceptually different layers of protocols for exchanging information over a network are described in the Open Systems Interconnection (OSI) Reference Model.

Communications between the network nodes are effected, for example, by exchanging discrete packets of data. Each packet comprises, for example, (1) header information associated with a particular protocol, and (2) payload information that follows the header information and contains information that may be processed independently of that particular protocol. In some protocols, the packet includes (3) trailer information following the payload and indicating the end of the payload information. The header includes information such as the source of the packet, its destination, the length of the payload, and other properties used by the protocol. Often, the data in the payload for the particular protocol includes a header and payload for a different protocol associated with a different, higher layer of the OSI Reference Model. The header for a particular protocol indicates, for example, a type for the next protocol contained in its payload. The higher layer protocol is said to be encapsulated in the lower layer protocol. The headers included in a packet traversing multiple heterogeneous networks, such as the Internet, include, for example, a physical (layer 1) header, a data-link (layer 2) header, an internetwork (layer 3) header and a transport (layer 4) header, and various application headers (layer 5, layer 6 and layer 7) as defined by the OSI Reference Model.

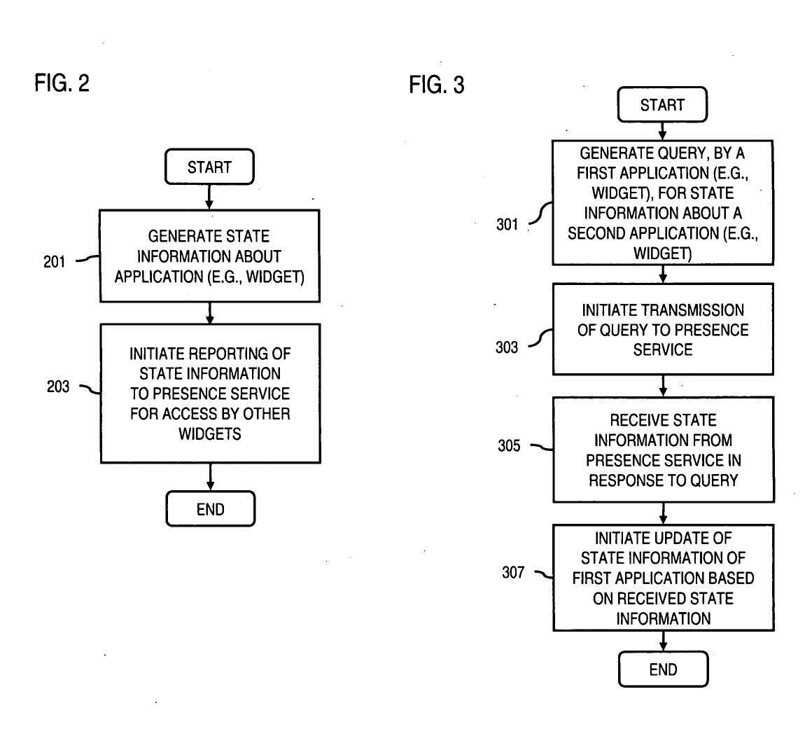

FIG. 2 is a flowchart of a process for reporting state information to a presence service, according to one embodiment. By way of example, this process is described with respect to the applications 109a within user equipment 101a and enables update of settings and content of the applications 109a. In step 201, state information about a particular one of the applications (e.g., widget 109a) is generated. Such state information is then reported to the presence service 103 over the communication network 105, per step 203. The state information is stored in the database 107 by the presence service 103 for access by other applications 109a of UE 101a.

As mentioned, the presence service platform 103 facilitates the exchange of state information among widgets executed within a particular user equipment; however, it is contemplated that such exchange can occur among widgets within separate user equipment.

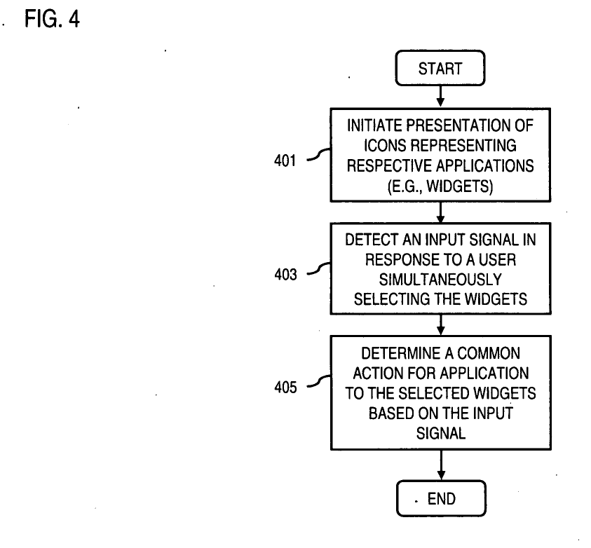

FIG. 3 is a flowchart of a process for sharing state information among applications, according to one embodiment. Continuing with the example of FIG. 2, widget A generates a query for state information about widget B, as in step 301. In step 303, transmission of the query is initiated by the process to the presence service 103. Thereafter, the UE 101a transmits the query over the network 105 to the presence service 103, which retrieves the appropriate state information and generates a response specifying the retrieved information. The response is then forwarded to the requesting widget A. In step 305, state information is received by widget A from the presence service 103; widget A initiates, per step 307, update of its own state information based on the received state information of widget B.

Based on the above process, a widget can be considered either as a reactive widget or an active widget. In a reactive mode of operation, widget A can periodically access presence service 103 (or waits to be notified by presence service 103) to query state of a particular widget or type of widget, on a specific system or a number of systems (for example widget-type@user@domain, or widgetA@user@domain). The query can specify parameter(s) relating to information sought by the widget about other one or more widgets, such as widget B. Accordingly, the response by the presence service 103 can contain the result parameters as available in the presence service for the queried widget(s). Based on the response, the widget A updates itself according to, for instance, a certain application logic. The state change may, in addition to or in the alternative, trigger initiating widget to update its status on presence service 103 along with one or more state parameters.

Another mode of operation is that of “active.” In this case, upon user interaction, for example movement of one or more widget icons, the state of the widget can change. In one embodiment, application logic state associated with the widget can specify whether the widget is active or inactive, placement of the widget on the UI, widgets (or widget types) neighboring the widget on the user screen, widget location on the UI, widget shortcut menu placement, input the widget last had, keywords of current widget content, current widget content identification, current widget status information, current widget context information, etc. Any set of that information can be communicated to presence service 103, which in turn records the communicated data in database 107 as any attribute-value pair, where value can be scalar value or any matrix. After, during, or even before the state communication the active widget can act as reactive widget and run the procedure for reactive operation.

As a further illustration, users, X and Y, utilize widgets A and B, respectively. In this example, user X has located widget A of a certain type next to a TV channel widget, while user Y has located widget B of another type next to the TV channel widget. The TV channel widget is active, and polls its source for content, when displaying advertisements. The source can be presence service 103 in which case the TV channel widget directly requests presence information. In an alternative embodiment, the source can be a proxy service that further consults presence service 103. The TV widget can issue a direct or indirect query to the source (or presence service 103) to request the following information: types and quantity of the neighboring widgets. Based on the received information, the TV widget (or source) may determine the appropriate ad to be displayed on the TV channel widget.

According to certain embodiments, the described processes leverage the presence services 103 as a platform for inter-widget communication, either directly or indirectly. Further, the use of widget typing removes the need to know exactly the identifier of the widget that is the subject of the query. This, thus, minimizes overhead.

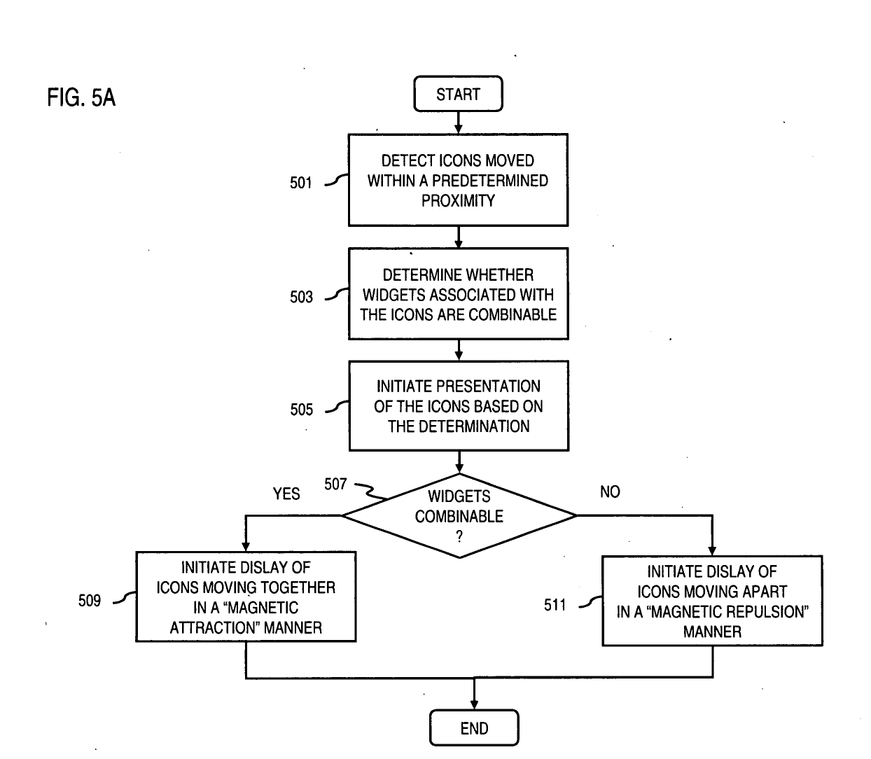

Furthermore, the presence service 103 can support the ability to associate widgets in a manner that visually alerts the user of whether such association (e.g., sharing of information, execution of a common action, etc.) is permissible. In one aspect, a common command or action can be applied to group of selected widgets. In another aspect, two widgets can be combined or associated with each other in a way that is intuitive to the user. These capabilities are further detailed below with respect to FIGS. 4-8.

FIG. 4 is a flowchart of a process for associating applications, according to one embodiment. For the purposes of illustration, this process is explained with respect to one or more relating applications or widgets with each other in the user interface (UI) environment. As shown, in step 401, the process initiates presentation of icons representing respective applications, e.g. widgets. An input signal is detected in response to a user simultaneously, concurrently, and/or sequentially selecting the one or more widgets, per step 403. Next, the process determines, as in step 405, a common action for application to the selected widgets based on the input signal. Moreover, the widgets can stick together for a certain period of time to indicate that a certain defined action (e.g., update) is in execution; and when complete, the widgets can be separated, remain next to each other, or return to their original location(s).

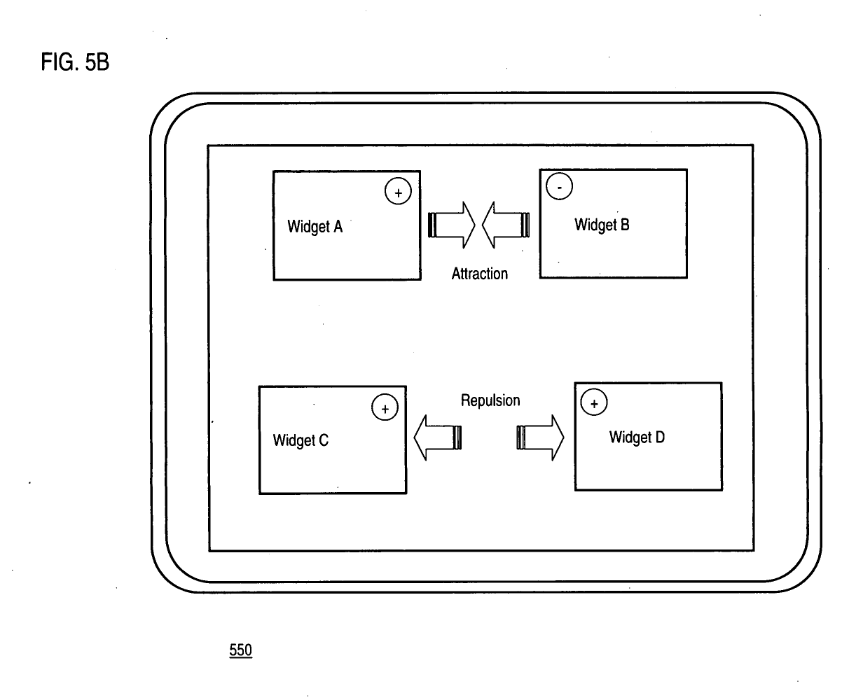

FIGS. 5A and 5B are, respectively, a flowchart of a process for displaying the association of applications, and a diagram of a visual presentation of the association, according to various embodiments. As seen in FIG. 5A, in step 501, the process detects icons corresponding to widgets 109a being moved within a predetermined proximity, or made to partially overlap. Next, it is determined whether the subject widgets 109a can be associated, per step 503. In step 505, the process initiates presentation of the icons based on the determination. This determination can be made based on state information obtained from presence service 103, as previously described; namely, the state information can include a field specifying how and what information can be combined with other widgets. According to certain embodiments, widgets 109a may have a general level of the Application Programming Interface (API) classes or types, wherein at least one or more API classes or types affect and controlled by device drivers control. In this manner, the widget of certain API classes or types can either accept cooperation or deny cooperation. In one embodiment, the API may refer to simple mail transfer protocol (SMTP).

In step 507, the process determines whether the widgets are combinable. If the widgets are combinable (e.g., capable of cooperation), the process initiates display of the icons moving together in a “magnetic attraction” manner (step 509). As mentioned, the widgets A-D may include data components that specify their magnetic property or polarity (e.g., “+” or “−”) with respect to the particular action. The selected widgets would be drawn together, such as widgets A and B shown in a display 550 of FIG. 5B. For example, assuming the display 550 supports a touch interface, when the user attempts to associate widgets A and B by dragging the widgets towards a common midpoint, these widgets will “snap” together. However, if the widgets cannot be combined, the display 550 shows the icons of the widgets, e.g. widgets C and D, as repelling away from each other in a “magnetic repulsion” manner (step 511).

In one use case, a user of UE 101a installs widget A into a widget framework. The user then inputs information X to the installed widget A, and moves the widget location on screen or display of UE 101a next to a previously installed widget B. The following two actions can be performed based on the information that user has previously installed widgets A and B (assuming widget B has input X and widgets A and B are located next to each other). In the first case, the user enters widget discovery service and is presented widget C. The decision to display widget C can be based on the inter-widget state knowledge. As for the second case, widget B is refreshed with new content. For example, widget B is TV guide widget and widget A is of type video widget—or some specific video widget—displaying TV channel, and the update is for widget B to show the TV guide listing for the channel that widget A represents. As shown, the combinability of these widgets can be indicated by the magnetic movement.

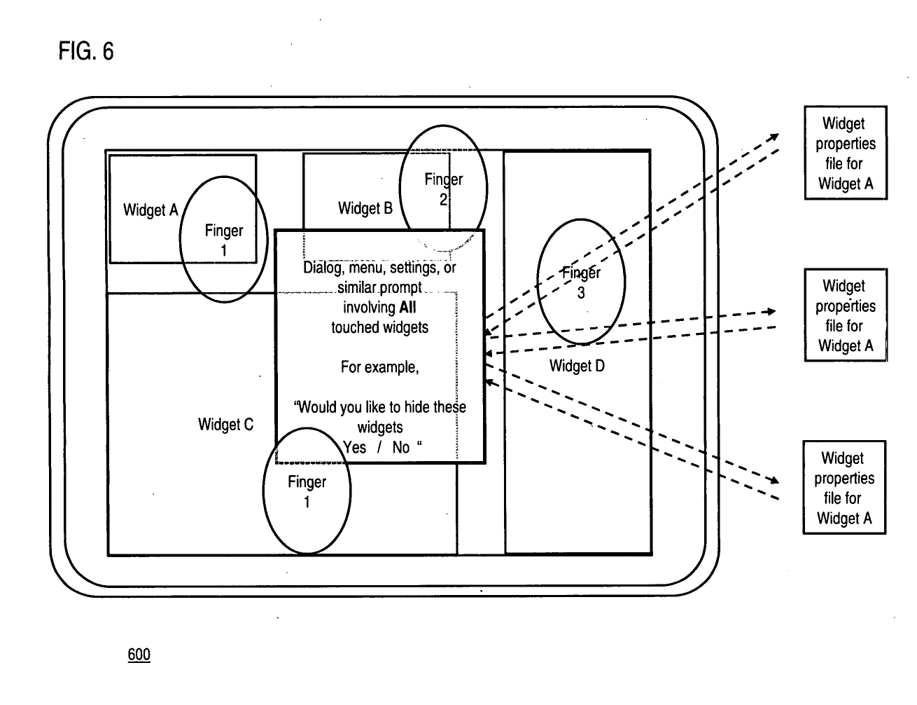

FIGS. 6-8 are diagrams of a multi-touch user interface for associating widgets, according to various embodiments. For the purposes of illustration the interface of FIGS. 6-8 is that of a multi-touch display. However, it is contemplated that other user input mechanisms can be utilized to permit concurrent selection of icons associated with the applications, e.g. widgets. In the example of FIG. 6, interface 600 illustrates such a scenario involving simultaneous selection of the widgets through the touch input, as indicated by Fingers 1, 2, and 3, to apply a common command or action. Initially, widget A is selected using Finger 1, thereby invoking widget properties for widget A. Next, the user can simultaneously select widgets B, C, and D using Fingers 1, 2, and 3. Such selection can cause a text box to appear that ties the selected widgets B, C, and D to an action defined as part of widget A. For instance, the text prompt “Would you like to hide these widgets Yes/No” (which is associated with widget A) can be presented to the user to take action for widgets B, C, and D. If the user provides an input of “Yes,” then widgets B, C, and D would be hidden (e.g., as a background process).

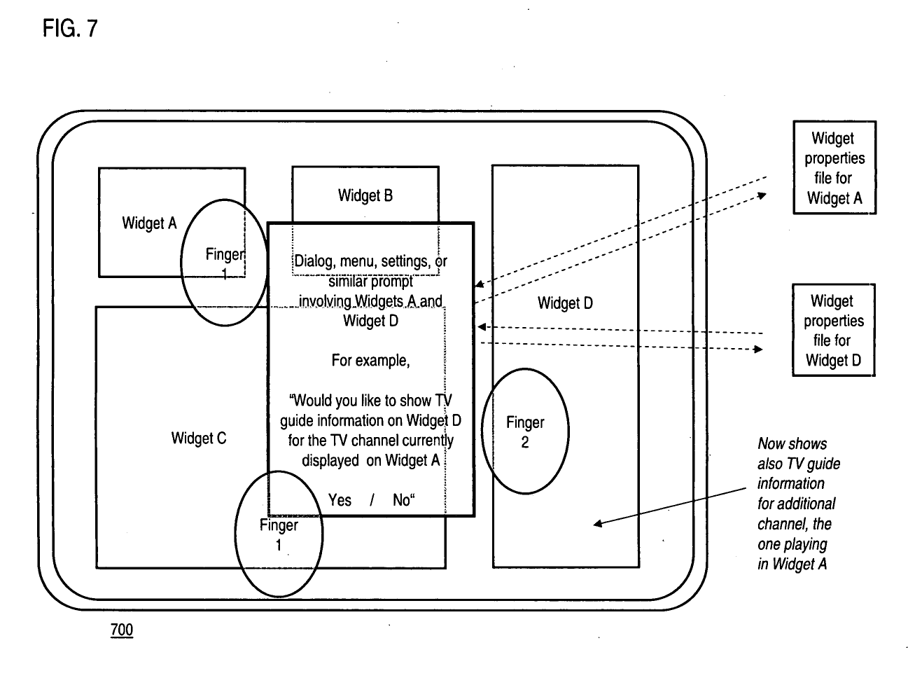

The example of FIG. 7 pertains to an attempt by the user (in interface 700) to associate two widgets, widget A and widget D. Under this scenario, widget A is presenting a particular TV channel, and widget D provides TV guide information. The user uses Finger 1 and Finger 2 to select widgets A and D and moves the widgets A and D together. Although not illustrated, a successful association can be visually presented when widget A and widget D attracts. After the display of magnetic-like attraction, widgets A and D can resume their respective positions. As shown, a text prompt, “Would you like to show TV guide information on Widget D for the TV channel currently displayed on Widget a Yes/No.” Here, the user selects Yes (using Finger 1), and thus, widget D now is updated to show TV guide information for the channel being played on widget A. The determination of whether the association is possible can be based on state information provided by presence service 103, as earlier described.

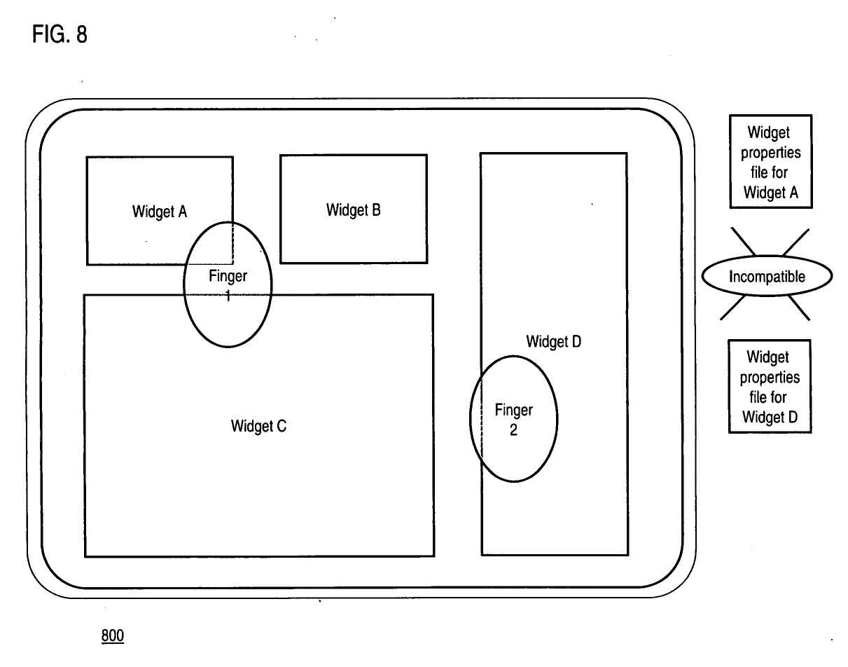

FIG. 8 shows an interface 800 involving a situation in which the selected widgets are not combinable. As before, the user can select widget A and widget D using Finger 1 and Finger 2 to attempt to bring the widgets together. However, the interface 800 can indicate that the selected widgets cannot be combined by the widgets repelling each other. In such a case, the operations of widget A and widget D remain independent—e.g., no information is shared.

The above arrangement, in certain embodiments, permits the efficient manipulation of applications. For example, the number of key strokes (or user input steps) performed by the users can be minimized, resulting in power savings. Furthermore, the use of state information permits enhanced coordination of applications; in this manner, the applications can optimize retrieval and use of network resources to avoid duplicative processes.

The processes described herein for providing association of applications and exchange of state information for these applications may be implemented via software, hardware, e.g., general processor, Digital Signal Processing (DSP) chip, an Application Specific Integrated Circuit (ASIC), Field Programmable Gate Arrays (FPGAs), etc., firmware or a combination thereof. Such exemplary hardware for performing the described functions is detailed below.

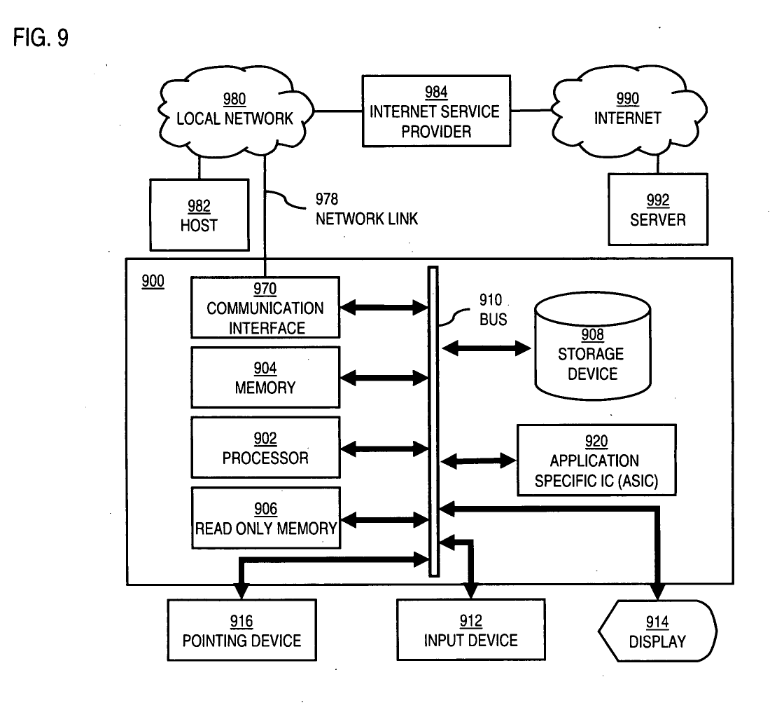

FIG. 9 illustrates a computer system 900 upon which an embodiment of the invention may be implemented. Computer system 900 is programmed to provide applications, e.g. widgets as described herein and includes a communication mechanism such as a bus 910 for passing information between other internal and external components of the computer system 900. Information (also called data) is represented as a physical expression of a measurable phenomenon, for example electric voltages, but including, in other embodiments, such phenomena as magnetic, electromagnetic, pressure, chemical, biological, molecular, atomic, sub-atomic and quantum interactions. For example, north and south magnetic fields, or a zero and non-zero electric voltage, represent two states (0, 1) of a binary digit (bit). Other phenomena can represent digits of a higher base. A superposition of multiple simultaneous quantum states before measurement represents a quantum bit (qubit). A sequence of one or more digits constitutes digital data that is used to represent a number or code for a character. In some embodiments, information called analog data is represented by a near continuum of measurable values within a particular range.

A bus 910 includes one or more parallel conductors of information so that information is transferred quickly among devices coupled to the bus 910. One or more processors 902 for processing information are coupled with the bus 910.

A processor 902 performs a set of operations on information related to associating widgets as well as reporting and retrieval of state information. The set of operations include bringing information in from the bus 910 and placing information on the bus 910. The set of operations also include, for example, comparing two or more units of information, shifting positions of units of information, and combining two or more units of information, such as by addition or multiplication or logical operations like OR, exclusive OR (XOR), and AND. Each operation of the set of operations that can be performed by the processor is represented to the processor by information called instructions, such as an operation code of one or more digits. A sequence of operations to be executed by the processor 902, such as a sequence of operation codes, constitute processor instructions, also called computer system instructions or, simply, computer instructions. Processors may be implemented as mechanical, electrical, magnetic, optical, chemical or quantum components, among others, alone or in combination.

Computer system 900 also includes a memory 904 coupled to bus 910. The memory 904, such as a random access memory (RAM) or other dynamic storage device, stores information including processor instructions for associating widgets. Dynamic memory allows information stored therein to be changed by the computer system 900. RAM allows a unit of information stored at a location called a memory address to be stored and retrieved independently of information at neighboring addresses. The memory 904 is also used by the processor 902 to store temporary values during execution of processor instructions. The computer system 900 also includes a read only memory (ROM) 906 or other static storage device coupled to the bus 910 for storing static information, including instructions, that is not changed by the computer system 900. Some memory is composed of volatile storage that loses the information stored thereon when power is lost. Also coupled to bus 910 is a non-volatile (persistent) storage device 908, such as a magnetic disk, optical disk or flash card, for storing information, including instructions, that persists even when the computer system 900 is turned off or otherwise loses power.

Information, including instructions for manipulating widgets, is provided to the bus 910 for use by the processor from an external input device 912, such as a keyboard containing alphanumeric keys operated by a human user, or a sensor. A sensor detects conditions in its vicinity and transforms those detections into physical expression compatible with the measurable phenomenon used to represent information in computer system 900. Other external devices coupled to bus 910, used primarily for interacting with humans, include a display device 914, such as a cathode ray tube (CRT) or a liquid crystal display (LCD), or plasma screen or printer for presenting text or images, and a pointing device 916, such as a mouse or a trackball or cursor direction keys, or motion sensor, for controlling a position of a small cursor image presented on the display 914 and issuing commands associated with graphical elements presented on the display 914. In some embodiments, for example, in embodiments in which the computer system 900 performs all functions automatically without human input, one or more of external input device 912, display device 914 and pointing device 916 is omitted.

In the illustrated embodiment, special purpose hardware, such as an application specific integrated circuit (ASIC) 920, is coupled to bus 910. The special purpose hardware is configured to perform operations not performed by processor 902 quickly enough for special purposes. Examples of application specific ICs include graphics accelerator cards for generating images for display 914, cryptographic boards for encrypting and decrypting messages sent over a network, speech recognition, and interfaces to special external devices, such as robotic arms and medical scanning equipment that repeatedly perform some complex sequence of operations that are more efficiently implemented in hardware.

Computer system 900 also includes one or more instances of a communications interface 970 coupled to bus 910. Communication interface 970 provides a one-way or two-way communication coupling to a variety of external devices that operate with their own processors, such as printers, scanners and external disks. In general the coupling is with a network link 978 that is connected to a local network 980 to which a variety of external devices with their own processors are connected. For example, communication interface 970 may be a parallel port or a serial port or a universal serial bus (USB) port on a personal computer. In some embodiments, communications interface 970 is an integrated services digital network (ISDN) card or a digital subscriber line (DSL) card or a telephone modem that provides an information communication connection to a corresponding type of telephone line. In some embodiments, a communication interface 970 is a cable modem that converts signals on bus 910 into signals for a communication connection over a coaxial cable or into optical signals for a communication connection over a fiber optic cable. As another example, communications interface 970 may be a local area network (LAN) card to provide a data communication connection to a compatible LAN, such as Ethernet. Wireless links may also be implemented. For wireless links, the communications interface 970 sends or receives or both sends and receives electrical, acoustic or electromagnetic signals, including infrared and optical signals, that carry information streams, such as digital data. For example, in wireless handheld devices, such as mobile telephones like cell phones, the communications interface 970 includes a radio band electromagnetic transmitter and receiver called a radio transceiver. In certain embodiments, the communications interface 970 enables connection to the communication network 105 for querying and retrieving state information of widgets.

The term computer-readable medium is used herein to refer to any medium that participates in providing information to processor 902, including instructions for execution. Such a medium may take many forms, including, but not limited to, non-volatile media, volatile media and transmission media. Non-volatile media include, for example, optical or magnetic disks, such as storage device 908. Volatile media include, for example, dynamic memory 904. Transmission media include, for example, coaxial cables, copper wire, fiber optic cables, and carrier waves that travel through space without wires or cables, such as acoustic waves and electromagnetic waves, including radio, optical and infrared waves. Signals include man-made transient variations in amplitude, frequency, phase, polarization or other physical properties transmitted through the transmission media. Common forms of computer-readable media include, for example, a floppy disk, a flexible disk, hard disk, magnetic tape, any other magnetic medium, a CD-ROM, CDRW, DVD, any other optical medium, punch cards, paper tape, optical mark sheets, any other physical medium with patterns of holes or other optically recognizable indicia, a RAM, a PROM, an EPROM, a FLASH-EPROM, any other memory chip or cartridge, a carrier wave, or any other medium from which a computer can read.

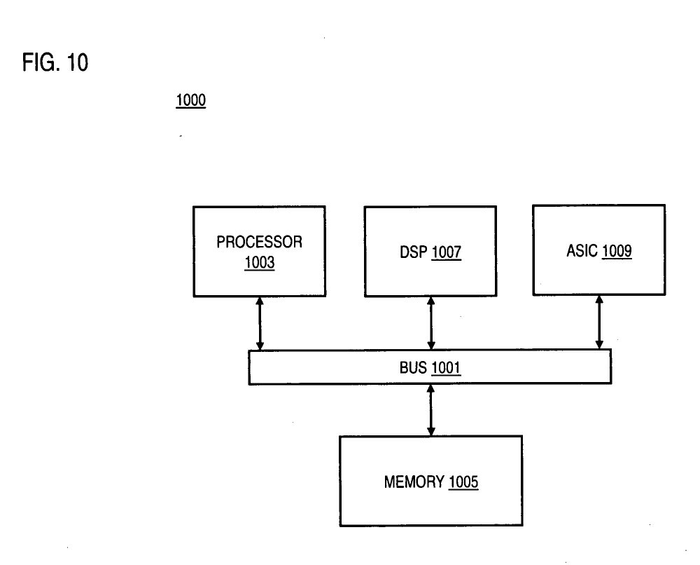

FIG. 10 illustrates a chip set 1000 upon which an embodiment of the invention may be implemented. Chip set 1000 is programmed to associate widgets and/or obtain state information as described herein and includes, for instance, the processor and memory components described with respect to FIG. 10 incorporated in one or more physical packages. By way of example, a physical package includes an arrangement of one or more materials, components, and/or wires on a structural assembly (e.g., a baseboard) to provide one or more characteristics such as physical strength, conservation of size, and/or limitation of electrical interaction.

In one embodiment, the chip set 1000 includes a communication mechanism such as a bus 1001 for passing information among the components of the chip set 1000. A processor 1003 has connectivity to the bus 1001 to execute instructions and process information stored in, for example, a memory 1005. The processor 1003 may include one or more processing cores with each core configured to perform independently. A multi-core processor enables multiprocessing within a single physical package. Examples of a multi-core processor include two, four, eight, or greater numbers of processing cores. Alternatively or in addition, the processor 1003 may include one or more microprocessors configured in tandem via the bus 1001 to enable independent execution of instructions, pipelining, and multithreading. The processor 1003 may also be accompanied with one or more specialized components to perform certain processing functions and tasks such as one or more digital signal processors (DSP) 1007, or one or more application-specific integrated circuits (ASIC) 1009. A DSP 1007 typically is configured to process real-world signals (e.g., sound) in real time independently of the processor 1003. Similarly, an ASIC 1009 can be configured to performed specialized functions not easily performed by a general purposed processor. Other specialized components to aid in performing the inventive functions described herein include one or more field programmable gate arrays (FPGA) (not shown), one or more controllers (not shown), or one or more other special-purpose computer chips.

The processor 1003 and accompanying components have connectivity to the memory 1005 via the bus 1001. The memory 1005 includes both dynamic memory (e.g., RAM, magnetic disk, writable optical disk, etc.) and static memory (e.g., ROM, CD-ROM, etc.) for storing executable instructions that when executed perform the inventive steps described herein to provide association of widgets and utilization of state information. The memory 1005 also stores the data associated with or generated by the execution of the inventive steps.

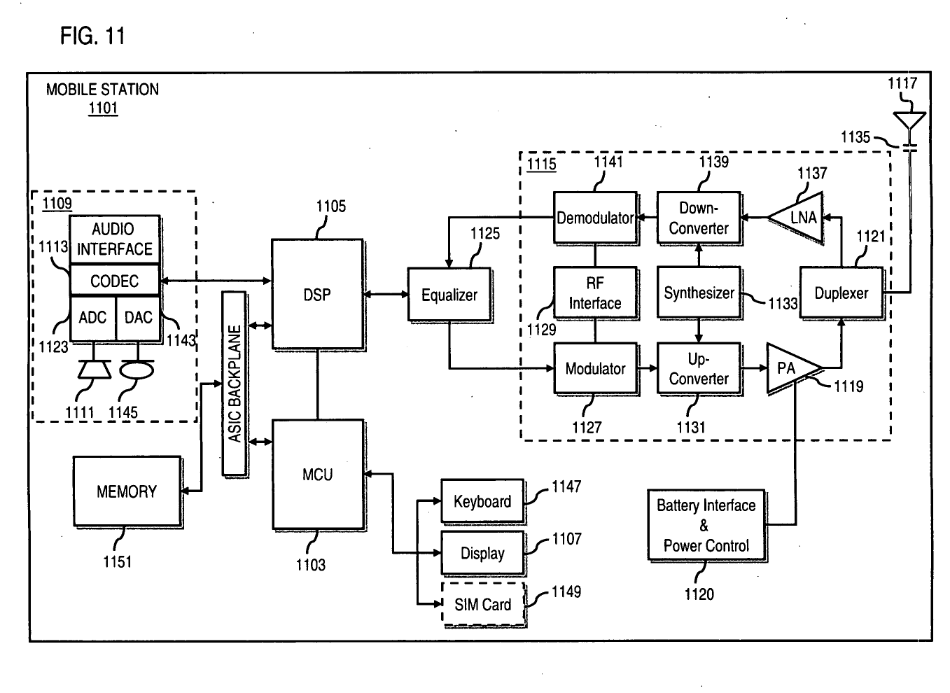

FIG. 11 is a diagram of exemplary components of a mobile station (e.g., handset) capable of operating in the system of FIG. 1, according to one embodiment. Generally, a radio receiver is often defined in terms of front-end and back-end characteristics. The front-end of the receiver encompasses all of the Radio Frequency (RF) circuitry whereas the back-end encompasses all of the base-band processing circuitry. Pertinent internal components of the telephone include a Main Control Unit (MCU) 1103, a Digital Signal Processor (DSP) 1105, and a receiver/transmitter unit including a microphone gain control unit and a speaker gain control unit. A main display unit 1107 provides a display to the user in support of various applications and mobile station functions, such as widgets. An audio function circuitry 1109 includes a microphone 1111 and microphone amplifier that amplifies the speech signal output from the microphone 1111. The amplified speech signal output from the microphone 1111 is fed to a coder/decoder (CODEC) 1113.

A radio section 1115 amplifies power and converts frequency in order to communicate with a base station, which is included in a mobile communication system, via antenna 1117. The power amplifier (PA) 1119 and the transmitter/modulation circuitry are operationally responsive to the MCU 1103, with an output from the PA 1119 coupled to the duplexer 1121 or circulator or antenna switch, as known in the art. The PA 1119 also couples to a battery interface and power control unit 1120.

In use, a user of mobile station 1101 speaks into the microphone 1111 and his or her voice along with any detected background noise is converted into an analog voltage. The analog voltage is then converted into a digital signal through the Analog to Digital Converter (ADC) 1123. The control unit 1103 routes the digital signal into the DSP 1105 for processing therein, such as speech encoding, channel encoding, encrypting, and interleaving. In one embodiment, the processed voice signals are encoded, by units not separately shown, using a cellular transmission protocol such as global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., microwave access (WiMAX), Long Term Evolution (LTE) networks, code division multiple access (CDMA), wireless fidelity (WiFi), satellite, and the like.

The encoded signals are then routed to an equalizer 1125 for compensation of any frequency-dependent impairments that occur during transmission though the air such as phase and amplitude distortion. After equalizing the bit stream, the modulator 1127 combines the signal with a RF signal generated in the RF interface 1129. The modulator 1127 generates a sine wave by way of frequency or phase modulation. In order to prepare the signal for transmission, an up-converter 1131 combines the sine wave output from the modulator 1127 with another sine wave generated by a synthesizer 1133 to achieve the desired frequency of transmission. The signal is then sent through a PA 1119 to increase the signal to an appropriate power level. In practical systems, the PA 1119 acts as a variable gain amplifier whose gain is controlled by the DSP 1105 from information received from a network base station. The signal is then filtered within the duplexer 1121 and optionally sent to an antenna coupler 1135 to match impedances to provide maximum power transfer. Finally, the signal is transmitted via antenna 1117 to a local base station. An automatic gain control (AGC) can be supplied to control the gain of the final stages of the receiver. The signals may be forwarded from there to a remote telephone which may be another cellular telephone, other mobile phone or a land-line connected to a Public Switched Telephone Network (PSTN), or other telephony networks.

Voice signals transmitted to the mobile station 1101 are received via antenna 1117 and immediately amplified by a low noise amplifier (LNA) 1137. A down-converter 1139 lowers the carrier frequency while the demodulator 1141 strips away the RF leaving only a digital bit stream. The signal then goes through the equalizer 1125 and is processed by the DSP 1105. A Digital to Analog Converter (DAC) 1143 converts the signal and the resulting output is transmitted to the user through the speaker 1145, all under control of a Main Control Unit (MCU) 1103-which can be implemented as a Central Processing Unit (CPU) (not shown).

The MCU 1103 receives various signals including input signals from the keyboard 1147. The keyboard 1147 and/or the MCU 1103 in combination with other user input components (e.g., the microphone 1111) comprise a user interface circuitry for managing user input. The MCU 1103 runs a user interface software facilitate user control of at least come functions of the mobile station 1101 according to, for example, an multi-touch user interface. The MCU 1103 also delivers a display command and a switch command to the display 1107 and to the speech output switching controller, respectively. Further, the MCU 1103 exchanges information with the DSP 1105 and can access an optionally incorporated SIM card 1149 and a memory 1151. In addition, the MCU 1103 executes various control functions required of the station. The DSP 1105 may, depending upon the implementation, perform any of a variety of conventional digital processing functions on the voice signals. Additionally, DSP 1105 determines the background noise level of the local environment from the signals detected by microphone 1111 and sets the gain of microphone 1111 to a level selected to compensate for the natural tendency of the user of the mobile station 1101.

The CODEC 1113 includes the ADC 1123 and DAC 1143. The memory 1151 stores various data including call incoming tone data and is capable of storing other data including music data received via, e.g., the global Internet. The software module could reside in RAM memory, flash memory, registers, or any other form of writable storage medium known in the art. The memory device 1151 may be, but not limited to, a single memory, CD, DVD, ROM, RAM, EEPROM, optical storage, or any other non-volatile storage medium capable of storing digital data.

An optionally incorporated SIM card 1149 carries, for instance, important information, such as the cellular phone number, the carrier supplying service, subscription details, and security information. The SIM card 1149 serves to identify the mobile station 1101 on a radio network. The card 1149 also contains a memory for storing a personal telephone number registry, text messages, and user specific mobile station settings.

While the invention has been described in connection with a number of embodiments and implementations, the invention is not so limited but covers various obvious modifications and equivalent arrangements, which fall within the purview of the appended claims. Although features of the invention are expressed in certain combinations among the claims, it is contemplated that these features can be arranged in any combination and order.

What is claimed is:

1. A method comprising:
initiating presentation of one or more icons representing one or more widgets;
detecting an input signal in response to a user selecting the one or more widgets; and
determining a common action for an application to the selected widgets based on the input signal, wherein the application includes a data component relating to combinability of the one or more widgets.

2. A method of claim 1, wherein the presentation is provided via a multi-touch user interface.

3. A method of claim 1, wherein the common action specifies associating the selected widgets.

4. A method of claim 3, wherein the association of the selected widgets includes display of the corresponding icons as moving together in a magnetic attraction manner.

5. A method of claim 3, further comprising:
determining that the association cannot be performed,
wherein the corresponding icons of the selected widgets are displayed as moving apart in a magnetic repulsion manner.

6. A method of claim 1, further comprising:
initiating transfer of information from one of the selected widgets to another one of the selected widgets.

7. An apparatus comprising:
at least one processor; and
at least one memory including computer program code,
the at least one memory and the computer program code configured to, with the at least one processor, cause the apparatus to perform at least the following,
initiate presentation of one or more icons representing respectively one or more widgets,
detect an input signal in response to a user selecting the one or more widgets, and
determine a common action for application to the selected widgets based on the input signal, wherein the application includes a data component relating to combinability of the one or more widgets.

8. An apparatus of claim 7, wherein the presentation is provided via a multi-touch user interface.

9. An apparatus of claim 7, wherein the common action specifies associating the selected widgets.

10. An apparatus of claim 9, wherein the association of the selected widgets includes display of the corresponding icons as moving together in a magnetic attraction manner.

11. An apparatus of claim 9, wherein the apparatus is caused to further perform the following:
determine that the association cannot be performed,
wherein the corresponding icons of the selected widgets are displayed as moving apart in a magnetic repulsion manner.

12. An apparatus of claim 7, wherein the apparatus is caused to further perform the following:
initiate transfer of information from one of the selected widgets to another one of the selected widgets.

13. An apparatus of claim 7, wherein the apparatus is a mobile phone further comprising:
user interface circuitry and user interface software configured to facilitate user control of at least some functions of the mobile phone through use of a display and configured to respond to user input; and
a touch screen display and display circuitry configured to display at least a portion of a user interface of the mobile phone, the display and display circuitry configured to facilitate user control of at least some functions of the mobile phone and the simultaneous selection of the widgets.

14. A method comprising:
generating state information about a first application; and
initiating reporting of the state information to a presence service for access by a second application.

15. A method of claim 14, wherein the apparatus is caused to further perform:
generating a query for the state information of the second application;
initiating transmission of the query to the presence service; and
receiving the state information of the second application in response to the query.

16. A method of claim 15, further comprising:
initiating update of the state information of the first application based on the received state information of the second application.

17. A method of claim 14, wherein each of the applications includes a widget.

18. An apparatus comprising:
at least one processor; and
at least one memory including computer program code,
the at least one memory and the computer program code configured to, with the at least one processor, cause the apparatus to perform at least the following,
generate state information about a first application, and
initiate reporting of the state information to a presence service for access by a second application.

19. An apparatus of claim 18, wherein the apparatus is caused to further perform the following:
generate a query for the state information of the second application;
initiate transmission of the query to the presence service; and
receiving the state information of the second application in response to the query.

20. An apparatus of claim 19, wherein the apparatus is caused to further perform the following:
initiate update of the state information of the first application based on the received state information of the second application.
